(19) United States
(12) Patent Application Publication
(10) Pub. No.: US 2024/0336811 A1
(43) Pub. Date: Oct. 10, 2024

(54) Method for Improving Uneven Brightness of Display and Display Thereof

(71) Applicant: Jet Optoelectronics Co., Ltd., Taipei City (TW)

(72) Inventor: Wen-Chieh Hsieh, Taipei City (TW)

(21) Appl. No.: 18/511,199

(22) Filed: Nov. 16, 2023

(30) Foreign Application Priority Data
Apr. 6, 2023 (TW) 112112772

(51) Int. Cl. C09J 1/00; C09K 19/52; G02F 1/1333

(52) U.S. Cl. CPC C09J 1/00; C09K 19/52; G02F 1/13332; C09J 2203/318; C09J 2400/10

(57) ABSTRACT

A method for improving uneven brightness of display and the display thereof. The method is to coat a layer of silicon glue on the bonding surface of the liquid crystal display module and the front frame of the display. The silicon glue has the characteristic of being stretchable, and can reduce the pulling of the liquid crystal display module to reduce the problem of uneven brightness of the display, and can reduce the interference of the cumulative tolerance of the assembly parts of other displays on the liquid crystal display module.

### BACKGROUND OF THE INVENTION

### 1. Field of the Invention

The present invention relates to a method for improving uneven brightness of a display and the display thereof, in particular to a method for improving uneven brightness of a display using silicon glue and the display thereof.

### 2. Description of the Related Art

Nowadays, audio-visual entertainment occupies an important place for people's lives, so the display function of display screens used in various technological products such as mobile phone screens, smart TV screens, computer screens, and car screens become particularly important.

Moreover, in order to make better use of the display screens of various technological products, for example, design a rotating shaft or a lifting structure to adjust the angle or height of the display screen; however, the slight tolerances between the components during assembly of the various rotating shafts or lifting structures will result in cumulative tolerances for each component when the assembly is completed. The cumulative tolerance often leads to the problem of uneven brightness (Mura) in the liquid crystal display module (LCD module, LCM) of the display.

The uneven brightness refers to the phenomenon that the uneven brightness of the liquid crystal display module causes various marks and traces. The easiest way to determine such defect is to switch to black screen and other low-gray scale screens in a dark room, and then carefully observe from various angles to see if the liquid crystal display module has various uneven brightness, which may occur in forms of horizontal stripes or 45-degree angle stripes, straight cut squares, traces that appear in a certain corner of the liquid crystal display module or scattered randomly without a certain pattern.

In order to tackle the problem of uneven brightness, designs have been made to improve the rotating shaft or lifting structure of the display to reduce the cumulative tolerance which improves the problem of uneven brightness. However, with the linkage of the lifting structure or the increase of the rotation angle of the rotating shaft, the effect of improving the uneven brightness of the liquid crystal display module may be hindered. Therefore, an effective solution must be found in the limited space of the display to take into account the structural strength of the display.

In addition, conventionally used optical glue (OCA, Optical Clear Adhesive) or optical liquid glue (OCR, Optical Clear Resin, also known as water glue) is used for bonding between the liquid crystal display module and its front frame in conventional displays; however, the optical glue will produce pulling force after bonding and is difficult to control, which will lead to the problem of uneven brightness of the liquid crystal display module. In addition, since the optical liquid glue is cured by UV light irradiation, the pulling force generated after photo-curing will also cause uncontrollable uneven brightness of the liquid crystal display module.

Therefore, it is necessary to find other solutions that are able to effectively improve the uneven brightness of the liquid crystal display module in the display.

### SUMMARY OF THE INVENTION

In view of the above problems, the inventors of the present invention conceived and designed a method for improving the uneven brightness of a display, so as to improve the problem of uneven brightness occurred in the above-mentioned prior art.

The present invention provides a method for improving uneven brightness of a display, in which the display comprises a liquid crystal display module, a bonding layer, a front frame, a bracket, a rear frame and a connecting part, wherein the liquid crystal display module being located in front of the bonding layer, the front frame being located behind the bonding layer, and the liquid crystal display module and the front frame being bond and fixed by the bonding layer; the bracket being located behind the front frame, the rear frame being located behind the bracket, and the front frame and the rear frame being fixed by the bracket; and the connecting part being disposed on the rear frame to fix the display, wherein a silicon glue is used as the bonding layer to reduce the pulling force generated by the bonding layer on the liquid crystal display module and improve uneven brightness of the display.

The viscosity of the silicon glue may be 12,000˜90,000 cps, and according to the different viscosities of the silicon glue, the drying time may be 1 hour to 168 hours; after the silicon glue is hardened through natural drying, its Shore hardness may be 15-28, and its stretch rate (elasticity) may be 180-270%. Within this range of stretch rate, the liquid crystal display module will not be affected by the pulling force of the bonding layer, so as to improve the problem of uneven brightness of the display. When the stretch rate of the silicon glue is below 180%, the colloid will be harder after curing, resulting in a smaller range of stress absorption; on the other hand, when the stretch rate of the silicon glue is greater than 270%, the initial fluidity of the colloid may be high and thus the glue may easily overflow, and the structure may be soft after curing, which results in poor support of the assembly.

Preferably, the silicon glue is a composition composed of Hydroxyl terminated polydimethylsiloxane (Cas NO. 70131-67-8), Organosilane (Cas NO. 22984-54-9) and Carbon Black (Cas NO. 1333-86-4); wherein, based on the total weight of the composition, hydroxyl terminated polydimethylsiloxane is ≥85 wt %, organosilane is ≤10 wt %, and carbon black is ≤5 wt %, but both organosilane and carbon black are greater than 0 wt %, and hydroxyl terminated polydimethylsiloxane is less than 100 wt %, that is, the silicon glue must contain the above three components, and the content of these components must be within the above range, so that the viscosity of the silicon glue is between 12,000-90,000 cps, the Shore hardness is between 15-28 and the stretch rate (elasticity) is between 180-270%.

More preferably, the silicon glue is composed of 85 wt % hydroxyl terminated polydimethylsiloxane, 10 wt % organosilane and 5 wt % carbon black.

The composition of the above-mentioned silicon glue merely illustrates a better composition of the silicon glue, but is not limited thereto, as long as the above-mentioned viscosity range, Shore hardness range or stretch rate (elasticity) range of the silicon glue is achieved, it may also be used as the silicon glue of this invention.

Preferably, the display may be a car display, for example a central control screen in a front seat of a vehicle, or a screen in the back seat of the vehicle for entertainment.

By replacing the traditional optical glue or optical liquid glue (water glue) with the silicon glue as the bonding layer, the problem of uneven brightness of the display can be significantly improved even under the original display structure, that is, under the presence of obvious cumulative tolerance.

Preferably, the bracket is a hinge bracket, but is not limited thereto, as long as the bracket is able to fix the front frame and the rear frame, it may be used as the bracket of this invention.

In addition, when the silicon glue is used as the bonding layer, it may present the following advantages:

1. Save cost: save the use of screws or other mechanical parts during assembly.

2. Improve the yield rate: improve the uneven brightness caused by cumulative tolerance, so that the tolerance of the materials of each mechanical part may be relaxed and improve the yield rate.

3. Simplification of the work station: when assembling the display, the UV irradiation time of the optical liquid glue or the work station and man-hours for manual bonding of the optical glue may be reduced.

4. Maintain uniform brightness of the display: after the problem of uneven brightness is improved, the visual comfort of the user may also be improved.

5. Reduce the loss of materials of each mechanical part: the problem of repeated work may be prevented in advance, and reduce the loss of materials of each mechanical part caused by the need to reassemble the display due to uneven brightness.

Based on the above, the method for improving the uneven brightness of a display provided by the present invention can further improve the problem of uneven brightness of the display without changing the original display structure, and can reduce manufacturing costs and time as well.

Hereinafter, the technical characteristics of the present invention, that is, the method for improving uneven brightness of a display, are described through specific embodiments.

### BRIEF DESCRIPTION OF THE DRAWINGS

The present invention will now be described in more details hereinafter with reference to the accompanying drawings.

FIG. 1 is a top sectional view of a conventional display;

FIG. 2 is a partially enlarged top view of the silicon glue applied to the bonding layer of a conventional display;

FIG. 3 is a schematic diagram of the normal stress on the bonding layer between the liquid crystal display module and the front frame;

FIG. 4 is a diagram showing the coating path location of the silicon glue;

FIG. 5 is a diagram showing the result of using conventional optical glue as the bonding layer for the display; and

FIG. 6 is a diagram showing the result of using the silicon glue as the bonding layer for the display.

### DETAILED DESCRIPTION OF THE PREFERRED EMBODIMENTS

The following content will be combined with drawings to illustrate the technical content of the present invention through specific embodiments, and those skilled in the art can easily understand other advantages and effects of the present invention from the content disclosed in this specification. The present invention can also be implemented or applied through other different specific embodiments. Various modifications and changes may be made to the details in this specification based on different viewpoints and applications without departing from the spirit and scope of the present invention.

Unless otherwise defined, all terms (including technical and scientific terms) used in the present invention have the same meaning as commonly understood by one of ordinary skill in the art to which this invention belongs. It will be further understood that terms such as those defined in commonly used dictionaries should be interpreted as having definitions consistent with their meanings in the context of the relevant art and the present invention, and will not be interpreted in an idealized or overly formal sense unless expressly so defined herein.

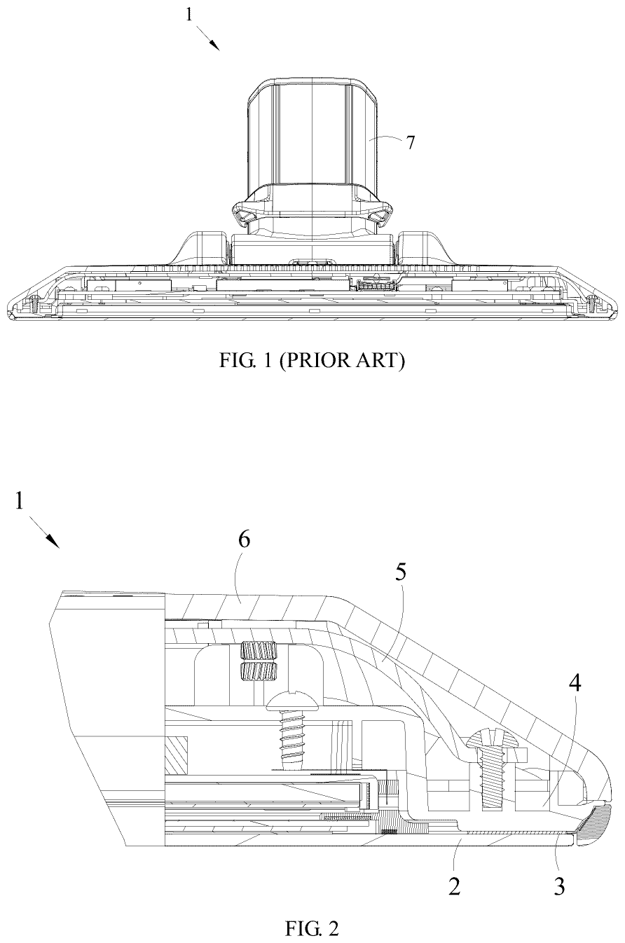

With reference to FIG. 1 and FIG. 2 for a top sectional view of a conventional display, and a partially enlarged top view of the silicon glue applied to the bonding layer of a conventional display.

The present invention provides a method for improving uneven brightness of a display 1, in which the display 1 comprises a liquid crystal display module 2, a bonding layer 3, a front frame 4, a bracket 5, a rear frame 6 and a connecting part 7, wherein the liquid crystal display module 2 being located in front of the bonding layer 3, the front frame 4 being located behind the bonding layer 3, and the liquid crystal display module 2 and the front frame 4 being bond and fixed by the bonding layer 3; the bracket 5 being located behind the front frame 4, the rear frame 6 being located behind the bracket 5, and the front frame 4 and the rear frame 6 being fixed by the bracket 5; and the connecting part 7 being disposed on the rear frame 6 to fix the display 1, wherein a silicon glue is used as the bonding layer 3 to reduce the pulling force generated by the bonding layer 3 on the liquid crystal display module 2 and improve uneven brightness of the display 1.

The viscosity of the silicon glue may be 12,000˜90,000 cps, and according to the different viscosities of the silicon glue, the drying time may be 1 hour to 168 hours; after the silicon glue is hardened through natural drying, its Shore hardness may be 15-28, and its stretch rate (elasticity) may be 180-270%. Within this range of stretch rate, the liquid crystal display module 2 will not be affected by the pulling force of the bonding layer 3, so as to improve the problem of uneven brightness of the display 1. When the stretch rate of the silicon glue is below 180%, the colloid will be harder after curing, resulting in a smaller range of stress absorption; on the other hand, when the stretch rate of the silicon glue is greater than 270%, the initial fluidity of the colloid may be high and thus the glue may easily overflow, and the structure may be soft after curing, which results in poor support of the assembly.

Preferably, the silicon glue is a composition composed of Hydroxyl terminated polydimethylsiloxane (Cas NO. 70131-67-8), Organosilane (Cas NO. 22984-54-9) and Carbon Black (Cas NO. 1333-86-4); wherein, based on the total weight of the composition, hydroxyl terminated polydimethylsiloxane is ≥85 wt %, organosilane is ≤10 wt %, and carbon black is ≤5 wt %, but both organosilane and carbon black are greater than 0 wt %, and hydroxyl terminated polydimethylsiloxane is less than 100 wt %, that is, the silicon glue must contain the above three components, and the content of these components must be within the above range, so that the viscosity of the silicon glue is between 12,000-90,000 cps, the Shore hardness is between 15-28 and the stretch rate (elasticity) is between 180-270%.

More preferably, the silicon glue is composed of 85 wt % hydroxyl terminated polydimethylsiloxane, 10 wt % organosilane and 5 wt % carbon black.

The composition of the above-mentioned silicon glue merely illustrates a better composition of the silicon glue, but is not limited thereto, as long as the above-mentioned viscosity range, Shore hardness range or stretch rate (elasticity) range of the silicon glue is achieved, it may also be used as the silicon glue of this invention.

Preferably, the display 1 may be a car display, for example a central control screen in a front seat of a vehicle, or a screen in the back seat of the vehicle for entertainment.

By replacing the traditional optical glue or optical liquid glue (water glue) with the silicon glue as the bonding layer 3, the problem of uneven brightness of the display can be significantly improved even under the original display structure, that is, under the presence of obvious cumulative tolerance.

Preferably, the bracket 5 is a hinge bracket, but is not limited thereto, as long as the bracket 5 is able to fix the front frame 4 and the rear frame 6, it may be used as the bracket 5 of this invention.

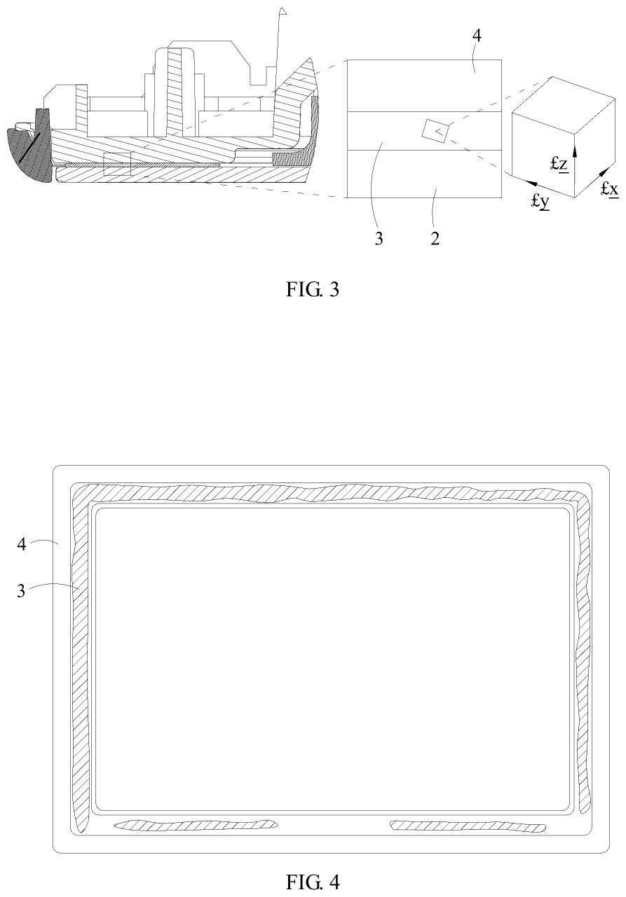

Next, with reference to FIG. 3 and FIG. 4, of which FIG. 3 is a schematic diagram of the normal stress on the bonding layer between the liquid crystal display module and the front frame, and FIG. 4 is a diagram showing the coating path location of the silicon glue.

As shown in FIG. 4, the silicon glue is coated along the periphery of the front frame 4 as the bonding layer 3, and it can be seen from FIG. 3 that the bonding layer 3 is subjected to normal stress δ from various directions. The normal stress δ refers to the stress perpendicular to the acting force and the acting surface, and is basically divided into normal stress δx, normal stress δy, and normal stress δz. The calculation formula of the normal stress δ is as follows:

$$δ = \frac{P}{A} \qquad Formula 1$$

$$δ x = \frac{E}{( 1 + v ) ( 1 - 2 v )} [ ( 1 - v ) ε x + v ( ε y + ε z ) ] \qquad Formula 2$$

$$δ y = \frac{E}{( 1 + v ) ( 1 - 2 v )} [ ( 1 - v ) ε y + v ( ε z + ε x ) ] \qquad Formula 3$$

$$δ z = \frac{E}{( 1 + v ) ( 1 - 2 v )} [ ( 1 - v ) ε z + v ( ε x + ε y ) ] \qquad Formula 4$$

$$E = \frac{δ}{ε} \qquad Formula 5$$

Wherein, P is the force perpendicular to the acting surface, A is the cross-sectional area of the acting force, E is Young's modulus (0.1 for silicon glue, 0.5 for optical liquid glue, and 2.5 for optical glue), ν is Poisson's ratio (0.5 for silicon glue, 0.45 for optical liquid glue, and 0.3 for optical glue), and & is the positive strain (since the value of the positive stress that is unknown, it is defined as a constant 1).

After using the above formulas 1˜5 and each numerical value into the calculation, the normal stress in each direction (δx, δy and δz) of the optical glue is 6.258, the normal stress in each direction (δx, δy and δz) of the optical liquid glue is 5.0ε, and the normal stress in each direction (δx, δy and δz) of the silicon glue is 0.2ε. Therefore, it can be seen that when the conventional optical liquid glue or optical glue is replaced by the silicon glue, the normal stress in each direction is significantly reduced.

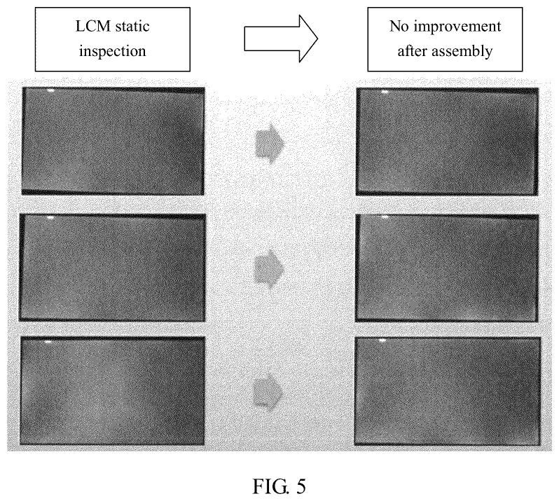

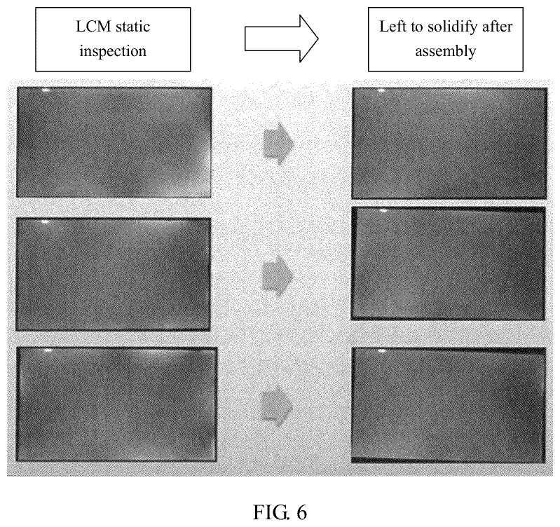

Finally, with reference to FIG. 5 and FIG. 6, of which FIG. 5 is a diagram showing the result of using conventional optical glue as the bonding layer for the display, and FIG. 6 is a diagram showing the result of using the silicon glue as the bonding layer for the display.

As can be seen from FIG. 5, compared with the uneven brightness of the liquid crystal display module 2 (LCD module, LCM) during static inspection, when assembled and attached to the front frame 4 and then inspected again, the problem of uneven brightness worsens. Therefore, it has been confirmed that when the conventional optical glue is used as the bonding layer 3 to attach the liquid crystal display module 2 to the front frame 4, the pulling force caused by insufficient stretch rate causes the uneven brightness of the liquid crystal display module 2 to worsen.

On the other hand, as can be seen from FIG. 6, after the liquid crystal display module 2 is assembled and attached to the front frame 4, and after the silicon glue is left to solidify, it is found that the uneven brightness of the liquid crystal display module 2 has been significantly improved compared with the use of conventional optical glue during inspection, and the problem of uneven brightness has been effectively reduced.

Furthermore, by using the silicon glue as the bonding layer 3, in addition to solving the problem of uneven brightness of the liquid crystal display module 2 (that is, maintaining uniform brightness of the display), it also has the advantages of saving costs, improving yield rate, simplifying work stations, and reducing material consumption of various mechanical parts.

Based on the above, the method for improving the uneven brightness of a display provided by the present invention can further improve the problem of uneven brightness of the display without changing the original display structure, and can reduce manufacturing costs and time as well.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A method for improving uneven brightness of a display, comprising:
using a silicon glue as a bonding layer to bond and fix a liquid crystal display module and a front frame of the display, thereby reducing the pulling force generated when the liquid crystal display module is bonded to the front frame and improve uneven brightness of the display.

2. The method of claim 1, wherein a viscosity of the silicon glue is 12,000˜90,000 cps.

3. The method of claim 1, wherein a Shore hardness of the silicon glue is 15˜28.

4. The method of claim 1, wherein a stretch rate of the silicon glue is 180˜270%.

5. A display, comprising a liquid crystal display module, a bonding layer, a front frame, a bracket, a rear frame and a connecting part, wherein
the liquid crystal display module being located in front of the bonding layer, the front frame being located behind the bonding layer, and the liquid crystal display module and the front frame being bond and fixed by the bonding layer;
the bracket being located behind the front frame, the rear frame being located behind the bracket, and the front frame and the rear frame being fixed by the bracket; and
the connecting part being disposed on the rear frame to fix the display, wherein
the bonding layer comprises a silicon glue to reduce the pulling force generated by the bonding layer on the liquid crystal display module and improve uneven brightness of the display.

6. The display of claim 5, wherein a viscosity of the silicon glue is 12,000˜90,000 cps.

7. The display of claim 5, wherein a Shore hardness of the silicon glue is 15˜28.

8. The display of claim 5, wherein a stretch rate of the silicon glue is 180˜270%.

9. The display of claim 5, wherein the display is a car display.

10. The display of claim 9, wherein the car display is a central control screen in a front seat of a vehicle, or a screen in the back seat of the vehicle for entertainment.
